(19) United States
(12) Patent Application Publication
(10) Pub. No.: US 2025/0046275 A1
(43) Pub. Date: Feb. 6, 2025

(54) PLECTRUM FOR STRINGED INSTRUMENT

(71) Applicant: Nilin Patel, Raleigh, NC (US)

(72) Inventor: Nilin Patel, Raleigh, NC (US)

(21) Appl. No.: 18/922,213

(22) Filed: Oct. 21, 2024

Related U.S. Application Data
(63) Continuation-in-part of application No. 29/820,985, filed on Dec. 27, 2021, now Pat. No. D048169.
(63) Continuation-in-part of application No. 29/917,663, filed on Nov. 21, 2023, now Pat. No. D051217.

(51) Int. Cl. G10D 3/173

(52) U.S. Cl. CPC G10D 3/173

(57) ABSTRACT

A plectrum for plucking or strumming a stringed instrument may include a grip portion defining a grip plane, a first tine extending from the grip portion at an oblique angle relative to the grip plane and defining a first tine tip, and a second tine extending from the grip portion along the grip plane and defining a second tine tip that protrudes beyond the first tine tip in both a lateral dimension and a longitudinal dimension.

### CROSS-REFERENCE TO RELATED APPLICATION(S)

This application is a continuation-in-part patent application of U.S. patent application Ser. No. 29/820,985, filed Dec. 27, 2021 and titled “Guitar Pick,” and this application is a continuation-in-part patent application of U.S. patent application Ser. No. 29/917,663, filed Nov. 21, 2023 and titled “Guitar Pick,” the disclosures of which are hereby incorporated herein by reference in their entireties.

### FIELD

The described embodiments relate generally to plectrums, or picks, for stringed instruments, such as guitars, mandolins, banjos, and the like.

### BACKGROUND

Stringed instruments may be played using various techniques. For example, the strings may be plucked or strummed with bare fingertips. As another example, plectrums, or picks, may be used. Different sounds may be achieved by using different picking and strumming techniques or implements.

### SUMMARY

A plectrum for plucking or strumming a stringed instrument may include a grip portion defining a grip plane, a first tine extending from the grip portion at an oblique angle relative to the grip plane and defining a first tine tip, and a second tine extending from the grip portion along the grip plane and defining a second tine tip that protrudes beyond the first tine tip in both a lateral dimension and a longitudinal dimension. The second tine tip may protrude beyond the first tine tip in the longitudinal dimension by between about 0.5 mm and about 4.0 mm. The second tine tip may protrude beyond the first tine tip in the lateral dimension by between about 0.25 mm and about 2.0 mm.

The oblique angle may be a first oblique angle, and the plectrum may further include a third tine extending from the grip portion at a second oblique angle relative to the grip plane and defining a third tine tip. The third tine may define a third tine tip, and the second tine tip may protrude beyond the third tine tip in both a lateral dimension and a longitudinal dimension.

The first tine may define a first edge extending from a first side of the grip portion and a second edge extending from a second side of the grip portion, the second tine may define a third edge extending from the first side of the grip portion and a fourth edge extending from the second side of the grip portion, the third tine may define a fifth edge extending from the first side of the grip portion and a sixth edge extending from the second side of the grip portion, and the first edge and the fifth edge may be coplanar, and the third edge may be noncoplanar with the first edge and the second edge. The second edge, the fourth edge, and the sixth edge may be coplanar.

A pick for a stringed instrument may include a grip portion configured to be grasped by a user and a tine portion extending from the grip portion and including at least two tines, each of the at least two tines configured to pluck a string of the stringed instrument. The at least two tines may include a first tine extending from the grip portion and defining a first tine tip and a second tine extending from the grip portion and defining a second tine tip, wherein a first line extending from a centroid of the grip portion to the first tine tip is oblique to a second line from the centroid of the grip portion to the second tine tip when the first and second lines is projected into a plane defined by a surface of the first tine. The second tine may have a greater surface area than the first tine.

The tine portion may further include a third tine extending from the grip portion and defining a third tine tip. A third line extending from a centroid of the grip portion to the third tine tip may be oblique to the second line from the centroid of the grip portion to the second tine tip when the third and second lines may be projected into a plane defined by the surface of the first tine. The second tine may extend along a same plane as the grip portion. The first tine may be oriented along a first tine plane that extends from the grip portion at a first angle, and the third tine may be oriented along a second tine plane that extends from the grip portion at a second angle. A magnitude of the first angle may be equal to a magnitude of the second angle.

A pick for a stringed instrument may include a grip portion configured to be grasped by a user, a tine portion extending from the grip portion and including at least two tines, each of the at least two tines configured to pluck a string of the stringed instrument, the at least two tines including a first tine extending from the grip portion and defining a first tine tip and a second tine extending from the grip portion and defining a second tine tip, the second tine tip offset from the first tine tip in at least a lateral dimension and a longitudinal dimension.

The tine portion may further include a third tine extending from the grip portion and defining a third tine tip, the second tine tip offset from the third tine tip in at least the lateral dimension and the longitudinal dimension. The second tine tip may be offset from the first tine tip and the second tine tip, in the lateral dimension, by a same distance. The second tine tip may be offset from the first tine tip and the second tine tip, in the longitudinal dimension, by a same distance.

The first tine tip and the third tine tip may be set apart from the second tine tip by a same distance. The pick may be symmetrical about a plane defined by the grip portion.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A-1C depict an example pick for a stringed instrument.

FIGS. 2A-2C depict additional views of the pick of FIGS. 1A-1C.

FIGS. 3A-3E depict an example pick engaging instrument strings.

FIGS. 4A-4C depict an example pick engaging instrument strings at various orientations.

FIGS. 5A-5B depict an example pick engaging instrument strings at various orientations.

FIG. 6 depicts another example pick for a stringed instrument.

FIGS. 7A-7B depict another example pick for a stringed instrument.

FIG. 8 depicts another example pick for a stringed instrument.

FIGS. 9A-9C depict various example picks for a stringed instrument, illustrating different grip configurations.

FIGS. 10A-10B depict another example pick for a stringed instrument.

FIGS. 11A-11B depict another example pick for a stringed instrument.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments as defined by the appended claims.

The embodiments herein are generally directed to plectrums, or picks, for stringed instruments. Picks may be used to pick individual strings of a stringed instrument, or multiple strings, such as in a “strumming” motion. Picks may be used with various types of stringed instruments, including but not limited to guitars, bass guitars, banjos, mandolins, dulcimers, harps, zithers, and the like. Picks or pick-like structures may also be implemented in keyed instruments, such as harpsichords, in order to pluck the instrument's strings.

Picks may be provided with different shapes, sizes, thicknesses, and other configurations, in order to produce different sounds or tones or other effects. For example, thicker picks may be capable of producing greater volume and may be preferred for picking individual strings, while thinner picks may be preferred by some players for playing quieter or for strumming chords. Conventionally, picks are relatively thin, flat structures that have a single tine or picking surface.

Described herein is a plectrum (or pick) for plucking or strumming a stringed instrument, in which the pick includes multiple tines protruding from a grip portion. The multiple tines may protrude at an angle from the grip portion, and may produce unique sounds and tones when used to play a stringed instrument. For example, as described herein, the multiple tines may be configured so that a single string can be plucked multiple times by a single motion. More particular, when a user plucks a string with a conventional picking motion, when using the picks described herein, the string may be plucked multiple times. This may lead to unique sounds that are not achievable with conventional picks.

Additionally, the picks described herein may have asymmetrically protruding tines, which may allow the pick to be held in multiple different ways to achieve different tones or other effects. The asymmetrical tines may also result in the tines interfacing with the strings at different angles and depths, which also contributes to the unique sounds that are achievable with the instant picks.

As noted above, picks may be used for strumming and plucking a stringed instrument. In the instant description, certain pick functions or uses may be described in the context of plucking individual strings. It will be understood that these discussions may apply equally to strumming motions, as strumming may be understood as a series of individual string plucks. Thus, for example, the manner in which a pick interfaces with a single string may be replicated for multiple strings when the strings are strummed. As used herein, strumming may refer to a motion in which a pick is swept across more than one string in a continuous motion, resulting in multiple strings being plucked or struck.

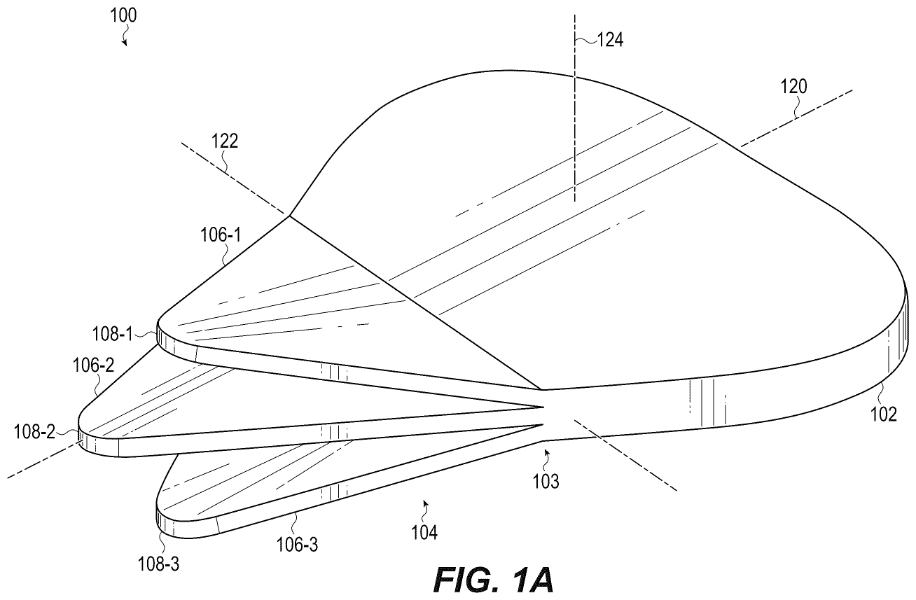

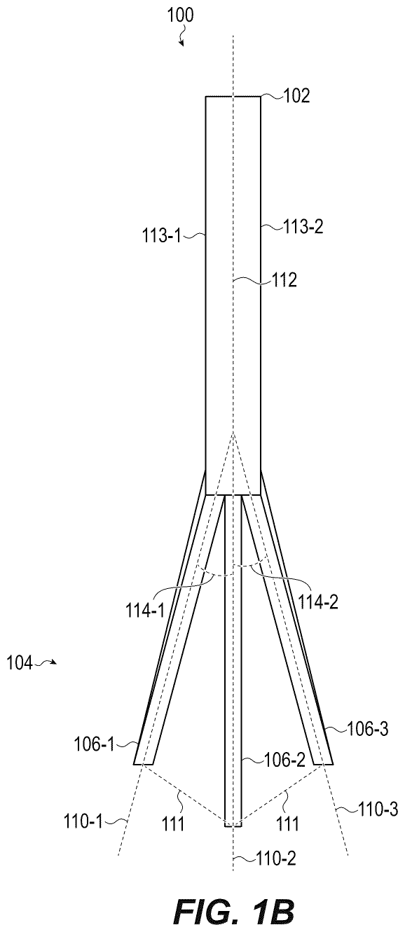

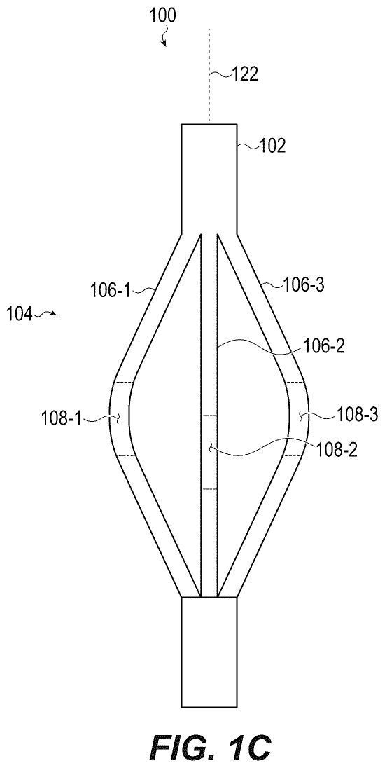

FIGS. 1A-1C illustrate an example pick 100 that includes multiple, asymmetrically protruding tines. In particular, the pick 100 includes a grip portion 102 and a tine portion 104. The grip portion 102 may be configured to be gripped or grasped by a user, such as between two fingers of a user (e.g., a thumb and index finger). The grip portion 102 may also be held in another implement, such as a pick holder (e.g., either to aid in the manual use of the pick 100, or to mount the pick 100 to a structure or mechanism of another instrument such as a harpsichord).

For ease of reference and description, FIG. 1A also illustrates an example coordinate system for the pick 100, including a longitudinal axis (or dimension) 120, a lateral axis (or dimension) 122, and a transverse axis (or dimension) 124. Unless otherwise indicated, all references to a longitudinal, lateral, or transverse axis or dimension will be understood to correspond to those shown in FIG. 1A. As used herein, a longitudinal axis or dimension of a pick may be used to refer to an axis or dimension that extends from the tip of the pick (e.g., a tip of a tine) to the spine or back of the pick, a lateral axis or dimension of a pick may be used to refer to an axis or dimension that extends from one side of the pick to the other side (e.g., perpendicular to the longitudinal dimension), and a transverse axis or dimension of a pick may be used to refer to an axis or dimension that is generally perpendicular or normal to the grip surfaces of the pick.

The tine portion 104 may join the grip portion 102 at a joining interface 103. In some cases, the pick 100 is a monolithic structure, and the joining interface 103 may simply correspond to the location of the monolithic structure where the tine portion 104 joins (and/or extends from) the grip portion 102.

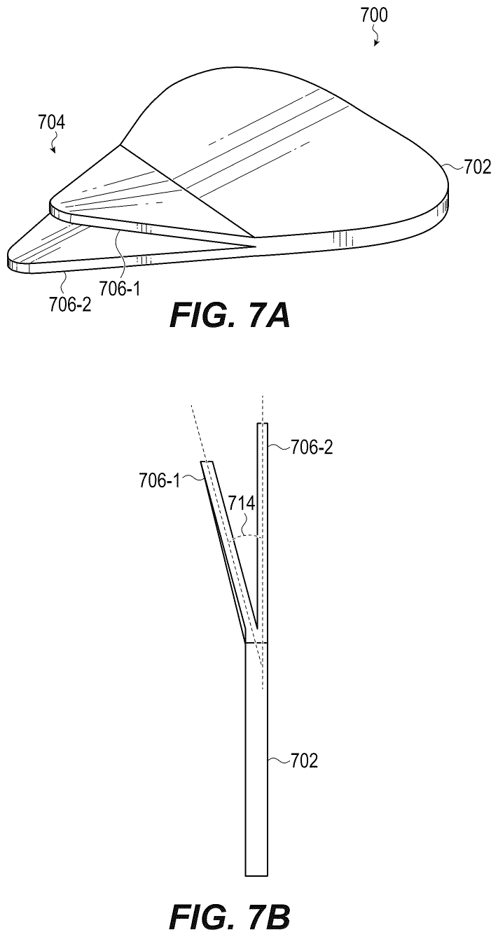

The tine portion 104 may include multiple tines 106, with each tine extending from the grip portion. FIGS. 1A-1C illustrate an example pick 100 with three tines 106 (106-1, 106-2, 106-3), this is merely one example, and other examples may include other numbers of tines, such as two tines, four tines, or the like. FIGS. 7A-7B illustrate an example pick with a tine portion having two tines.

The tines 106 may each define a tine tip. For example, the first tine 106-1 may define a first tine tip 108-1, the second tine 106-2 may define a second tine tip 108-2, and the third tine 106-3 may define a third tine tip 108-3. A tine tip 108 may generally define or correspond to the distal end of a tine, and may correspond to the portion of the tine that is furthest from a centroid of the grip portion of the pick 100. Additionally, in examples where the pick includes three tines, the second tine 106-1 may be referred to or correspond to a central tine.

As shown in FIGS. 1A-1C, the tines 106 may generally project or extend from the grip portion 102 at different angles. For example, as shown in FIG. 1B, the first tine 106-1 may extend from the grip portion 102 at a first angle 114-1 (e.g., an oblique angle) relative to a grip plane 112 defined by the grip portion 102, while the second tine 106-2 may extend from the grip portion 102 along the grip plane 112 (e.g., the second tine 106-2 may extend along the same plane as the grip portion 102). The third tine 106-3 may extend from the grip portion 102 at a second angle 114-2 (e.g., an oblique angle) relative to the grip plane 112. In examples where the tines 106 are generally flat, the tines may be oriented along tine planes that extend from the grip portion 102 at an angle. For example, the first tine 106-1 may be oriented along a first tine plane that extends from the grip portion at the first angle 114-1, and the third tine 106-3 may be oriented along a second tine plane that extends from the grip portion 102 at the second angle 114-2 (and the second tine 106-2 may extend along the grip plane 112).

As shown, the grip plane 112 may be defined through a center of the grip portion 102. In some cases, such as where the grip portion 102 defines two parallel grip surfaces 113-1, 113-2 (e.g., the grip portion 102 defining a substantially uniform thickness), the grip plane 112 may be parallel to the grip surfaces 113. Where the grip portion 102 tapers or curves or otherwise does not have parallel grip surfaces, the grip plane 112 may generally refer to a plane that is midway between the grip surfaces of the grip portion. Further, the tines 106 may each be substantially flat members, with planar tine surfaces. Like the grip portion 102, the tine surfaces of a given tine may be parallel to each other (e.g., defining a substantially uniform thickness). In some cases, the tines may be tapered, having a greater thickness proximate the joining interface 103.

The magnitude of the first angle 114-1 may be equal to the magnitude of the second angle 114-2. For example, the first and second angles may have a magnitude between about 5 degrees and about 25 degrees, or between about 10 degrees and about 20 degrees, or between about 12 degrees and about 18 degrees (or any value in these ranges). In some cases, the magnitude of the first and second angles is about 15 degrees. In some cases, the magnitudes of the first and second angles may differ. For example, the magnitudes of the first and second angles may differ by about 1.0 degree, about 2.5 degrees, about 5.0 degrees, about 10.0 degrees, or another value.

As described herein, the tine tips 108 of the tines 106 may be staggered or offset (relative to at least one other tine) in one or more dimensions. For example, FIG. 1C depicts the pick 100 viewed from the tine portion 104. As shown, the first tine tip 108-1 is offset from the second tine tip 108-2 in the lateral dimension 122, and the third tine tip 108-3 is also offset from the second tine tip 108-2 in the lateral dimension 122. Additionally, as shown and described herein, the first and third tine tips may also be offset from the second tine tip 108-2 in a second dimension (e.g., the longitudinal dimension 120). Offset tine tips as described herein may produce different sonic and tonal effects when used to pluck a string, and may allow for multiple ways for a player to engage the strings by changing the way they hold the pick.

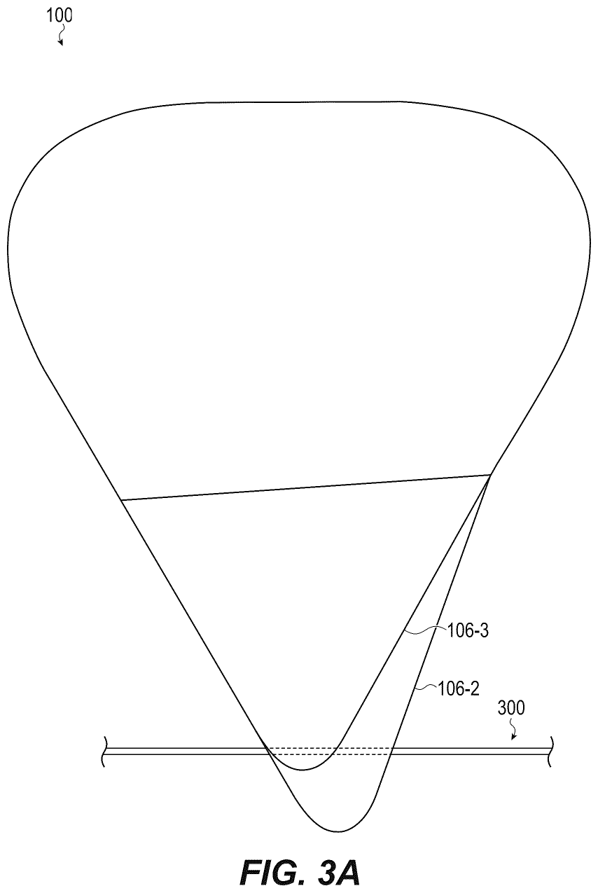

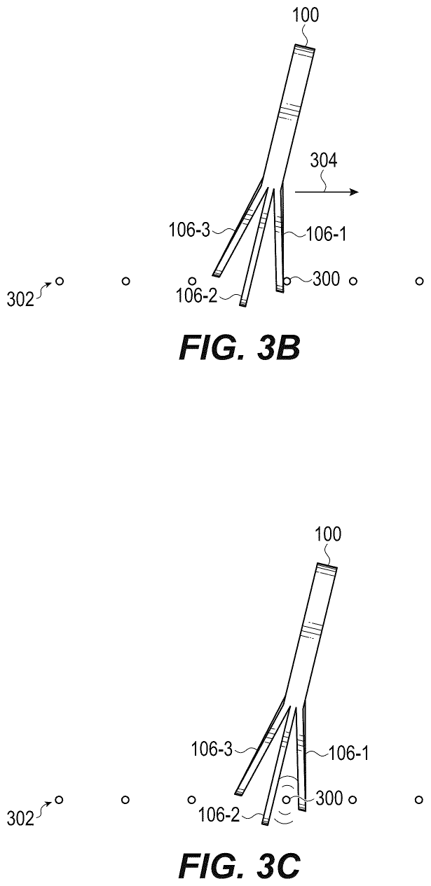

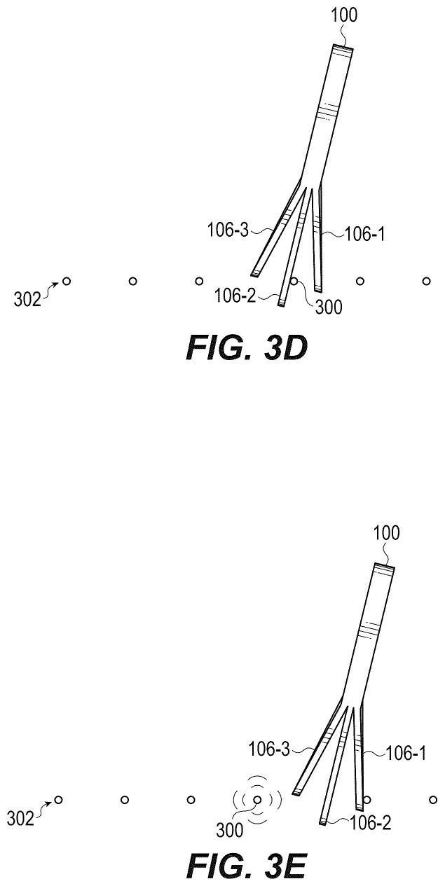

As shown in FIG. 1B, the tips of the outer tines 106-1, 106-3 may be set apart from the tip of the central tine 106-3 by an inter-tine distance 111. The inter-tine distance 111 may be between about 1.0 mm and about 7.0 mm, or between about 1.5 mm and about 6.0 mm, or between about 3.5 mm and about 5.0 mm (or any value in these ranges). In some cases, the inter-tine distance may be less than about 5.0 mm, or less than an inter-string spacing on a stringed instrument (e.g., the space between adjacent strings at the location where the string is plucked). By dimensioning the inter-tine distance between an outer tine and the center tine to less than an inter-string spacing of an instrument, the pick may be used to preferentially pick a single string at a time, and different tines of the pick will not simultaneously engage multiple strings (as shown in greater detail with respect to FIGS. 3A-3E). In some cases, the maximum width of the pick is about 10.0 mm, about 8.5 mm, about 7.0 mm, about 5.0 mm, or another suitable width.

While the example pick 100 includes three tines, the same principles of multiple tine tips being offset in multiple dimensions may also be applied to picks with two tines, or more than three tines. For example, in a two-tine pick a first tine tip may be offset in multiple dimensions from a second tine tip.

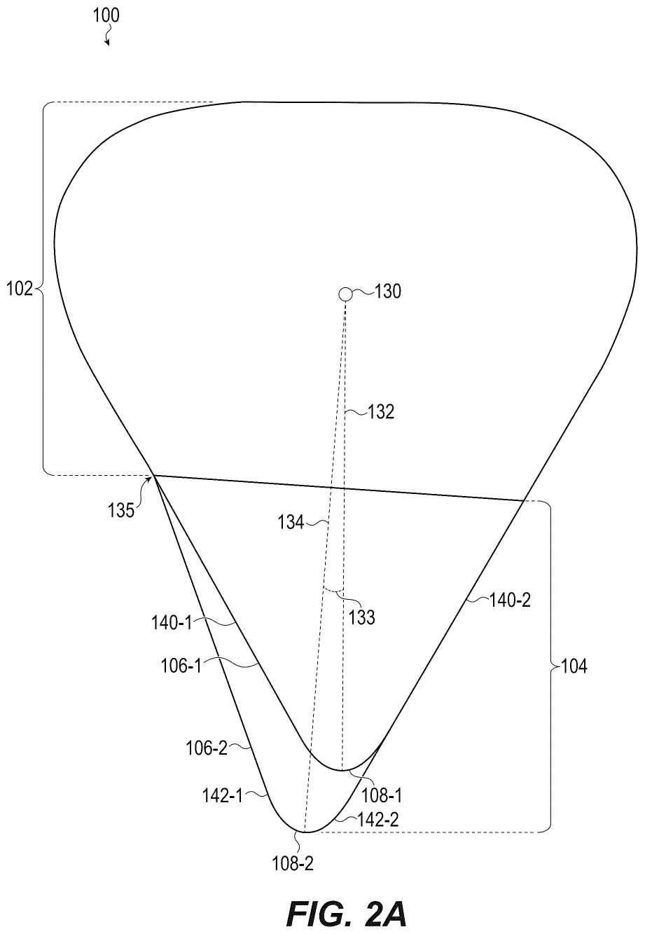

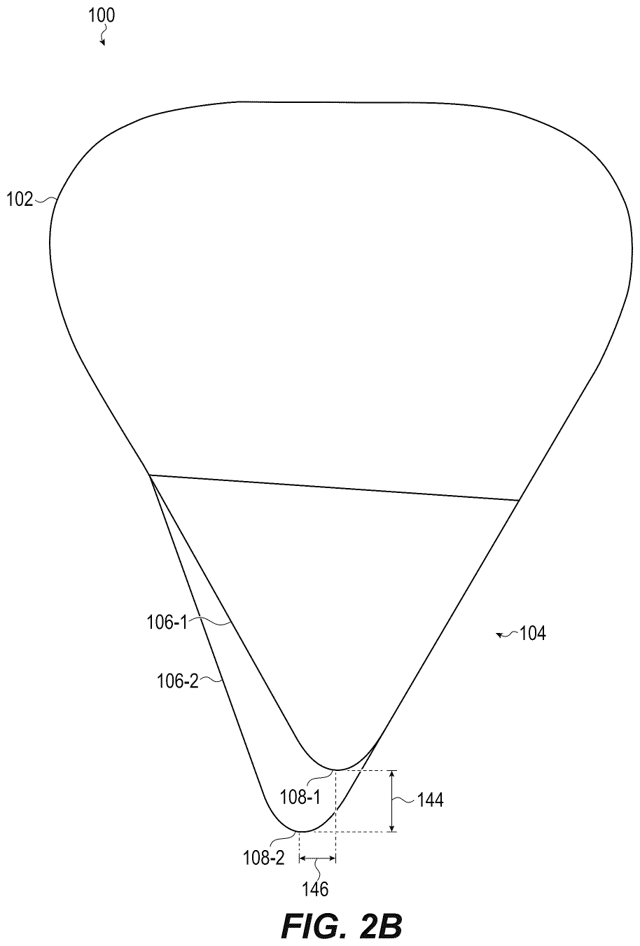

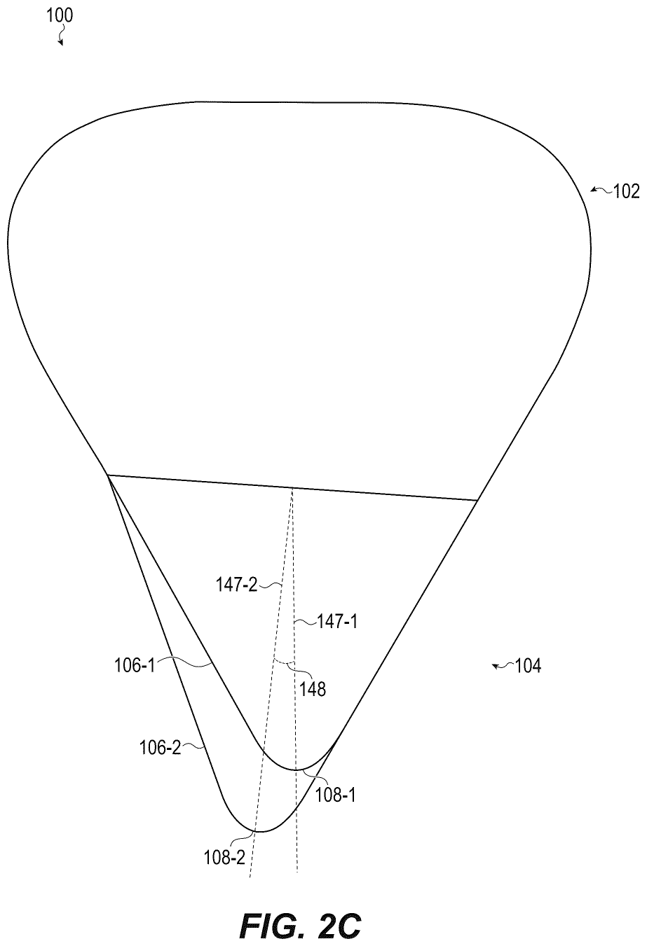

FIGS. 2A-2C further illustrate the offset or staggered configuration of the tines 106. For example, as shown in FIG. 2A, a first line 132 extending from a centroid 130 of the grip portion 102 to the first tine tip 108-1 is oblique to a second line 134 extending from the centroid 130 of the grip portion 102 to the second tine tip 108-2 (when the first and second lines are projected into a plane defined by a surface of the first tine, as illustrated in FIG. 2A). As used herein, a centroid of a shape may correspond to the geometric center of a shape, which may be calculated as the arithmetic mean position of all the points in the surface of the shape. An angle 133 between the first line 132 and the second line 134 may be between about 1 degree and about 10 degrees, or between about 2 degrees and about 4 degrees, or another suitable range (or any value in these ranges).

FIG. 2A also illustrates how the asymmetrical shapes of the tines results in different side profiles of the pick 100 as a whole. For example, the first tine 106-1 defines a first edge 140-1 extending from a first side of the grip portion 102 and a second edge 140-2 extending from a second side of the grip portion 102, and the second tine 106-2 defines a third edge 142-1 extending from the first side of the grip portion 102 and a fourth edge 142-2 extending from the second side of the grip portion 102. Additionally, while not visible in FIG. 2A, the third tine 106-3 defines a fifth edge extending from the first side of the grip portion 102 and a sixth edge extending from the second side of the grip portion 102. (The third tine 106-3 follows essentially the same shape as the first tine 106-1 when projected into the view of FIG. 2A.) As shown, the first edge 140-1 of the first tine 106-1 and the fifth edge of the third tine 106-1 are coplanar (or coincident, when projected into the plane shown in FIG. 2A), and the third edge 142-1 is noncoplanar with the first edge and the second edge. Also, the second edge 140-2, the fourth edge 142-2, and the sixth edge are all coplanar (or coincident, when projected into the plane shown in FIG. 2A). Stated another way, along one side of the pick 100, the middle or second tine 106-2 may project further in the lateral dimension than the first and third tines, while along the opposite side of the pick 100, the tines are all even (e.g., no tine protrudes along the lateral dimension). In some picks utilizing this tine configuration, one side of the pick is straight along the grip portion 102 and the tine portion 104, while the opposite side has a discontinuity or notch 135 where the protruding tine (here the second tine 106-2) joins the grip portion 102.

FIG. 2B illustrates how the tine tips 108 of the pick 100 may be positioned relative to one another in the lateral and longitudinal dimension to produce the asymmetrical and/or offset positioning described herein. As shown, the second tine tip 108-2 may protrude beyond (or be offset from) the first tine tip 108-1 by a first distance 146 in the lateral dimension, and may protrude beyond (or be offset from) the first tine tip 108-1 by a second distance 144 in the longitudinal dimension. The second tine tip 108-2 may protrude beyond the first tine tip 108-1 in the longitudinal dimension by between about 0.25 mm and about 6.0 mm, between about 0.5 mm and about 4.0 mm, or between about 1.0 mm and about 3.0 mm (or any value in these ranges). The second tine tip 108-2 may protrude beyond the first tine tip 108-1 in the lateral dimension by between about between about 0.25 mm and about 4.0 mm, 0.25 mm and about 2.0 mm, or between about 0.5 mm and about 1.5 mm (or any value in these ranges). As noted above, since the third tine tip 108-3 has generally the same shape and position as the first tine tip 108-1, when projected into the view of FIG. 2B, it will be understood that the relative positions of the third and second tine tips may be the same as between the first and second tine tips.

In some cases, the tines 106 may be generally triangular in shape, each having a side that joins the grip portion 102 at the joining interface 103, and each tine tip 108 generally corresponding to a vertex of the triangle. FIG. 2C illustrates how medians of the generally triangular tine tips 108 of the pick 100 may be oblique to each other, resulting in the asymmetrical and/or offset positioning of the tine tips as described herein. For example, as shown in FIG. 2C, the first tine 106-1 defines a first median 147-1 extending from a midpoint of the base of the tine 106-1 (e.g., the side of the first tine 106-1 that joins the grip portion 102) to the first tine tip 108-1. The second tine defines a second median 147-2 extending from a midpoint of the base of the tine 106-2 (e.g., the side of the second tine 106-2 that joins the grip portion 102) to the second tine tip 108-2. The first median 147-1 is oblique to the second median 147-2. For example, the first and second medians may form an angle 148, which may be between about 2.5 degrees and about 15 degrees, or between about 5 degrees and about 10 degrees (or any value in these ranges). As noted above, since the third tine 106-3 has generally the same shape as the first tine 106-1, when projected into the view of FIG. 2C, it will be understood that the relative positions of a median of the third tine and the median of the second tine may be the same as between the medians of the first and second tines.

While FIGS. 2A-2C illustrate one side of the pick 100 (and thus shows the first tine 106-1 and occludes or obscures the third tine 106-3), it will be understood that the third tine 106-3 may have the same general shape as the first tine 106-1, and as such, the geometric relationships between the first tine and the second tine may also be exhibited by the third tine and the second tine. Further, in some cases, the second tine 106-2 may have a greater surface area than the first and third tines, though this is not strictly necessary to achieve the offset and/or asymmetrical positioning of the tine tips. For example, the second tine 106-2 may have a different shape (e.g., a curved or crescent shape) with a tine tip positioned relative to the other tine tips as shown herein, but with a smaller surface area than the other tines.

FIGS. 3A-3E illustrate the pick 100 being used to pluck a string 300 of a stringed instrument. For example, the pick 100 is positioned relative to the string 300 such that the tines overlap the string 300. FIG. 3B illustrates a side view of the pick 100 prior to the string 300 being plucked. As shown, the first tine 106-1 is in contact with (or about to contact) the string 300, as would occur when the string 300 is being plucked (either individually or as part of a strumming motion). In this example, the pick 100 is being moved in the direction 304 in order to pluck the string 300.

As shown in FIG. 3C, as the pick 100 is moved in the direction 304, the first tine 106-1 plucks the string 300 (e.g., imparts a tension on the string 300 and then abruptly releases the tension as the string slides off or otherwise is released from the first tine 106-1). When the tine 106-1 plucks (e.g., releases) the string 300, the string may resonate or vibrate for a period of time before the second tine 106-2 contacts the string. The plucking and corresponding vibration of the string 300 may produce an audible output, which may be amplified by the instrument to which the string is attached (e.g., the soundbox or body of an acoustic guitar, violin, banjo, or the like, or by a pickup of an electric guitar, bass, or other electrically amplified instrument).

After the string 300 is plucked by the first tine 106-1, the second tine 106-2 may contact the string 300. As shown, the offset of the second tine 106-2 in the longitudinal direction helps ensure that the second tine 106-2 is in a position to engage the string 300, even when the pick 100 is held at an angle to the strings, as shown (which may be a common attack angle for playing a stringed instrument with a pick).

When the second tine 106-2 contacts the string 300, as shown in FIG. 3D, the second tine 106-2 may mute or otherwise terminate the vibration of the string that resulted from the first tine pluck. This string contact may itself produce an audible sound as the second tine 106-2 makes contact with the vibrating string 300.

As the picking motion continues, the second tine 106-2 may pluck (e.g., release) the string 300, as shown in FIG. 3E. Once the second tine 106-2 plucks the string, the third tine 106-3 may pass over or otherwise not engage the string 300, allowing the string 300 to continue vibrating, producing the note to which the string is tuned. When the picking motion described with respect to FIGS. 3A-3E is considered as a single continuous motion, the picking of the string 300 produces a unique sound, which may be fuller or include more (or different) sonic elements than plucking the string with a conventional pick or with a finger. More particularly, plucking the string with the pick 100 may result in an initial pluck, followed by a string mute, followed by a second pluck, each of which may be audible or contribute to the overall sound of the string pluck. As noted above, the plucking of the string 300 may be a single pluck, or it may be part of a strum, in which multiple strings are plucked in sequence. For example, one or more strings of a set of strings 302 may be plucked during a strumming motion, and each pluck may resemble the pluck described with respect to FIGS. 3B-3E. Since each string is plucked twice by the pick 100, the overall sound of the strum may be fuller or otherwise differ from other strumming techniques (e.g., a single flat pick or strumming with a finger).

As shown in FIG. 3E, the fact that the second tine 106-2 protrudes, along the longitudinal dimension, relative to both the first and third tines may result in the second tine 106-2 engaging the string after the first tine (or the leading tine), and also result in the third tine 106-3 (or trailing tine) not striking the string. In some cases, however, the pick 100 may be held or used in such a manner that all three tines pluck the string in sequence, resulting in additional or different sounds or sonic effects. Additionally, the particular tine configuration of the pick 100 also allows a player to achieve the same or similar sounds during both downstrokes and upstrokes of the pick. That is, when a player reverses the pick direction (and optionally reverses the pick attack angle to generally maintain a consistent pick attack angle), the same or similar sonic effects may be achieved, but with a different tine acting as the leading tine (e.g., the third tine 106-3 would be the leading tine, based on the orientation shown in FIGS. 3B-3E).

While not illustrated in FIGS. 3B-3E, the pick 100, and/or the tines 106 more specifically, may flex when the string is plucked. The amount of flex may depend on various factors, such as the geometry of the tines (e.g., thickness, shape, etc.), the material of the tines, the pick angle, the amount of force or speed with which the string is plucked, and the like. In some cases, picks having the instant design may be provided in multiple different thicknesses, materials, tine shapes, grip shapes, and the like, in order to allow players to select the particular pick configuration that suits their preferences.

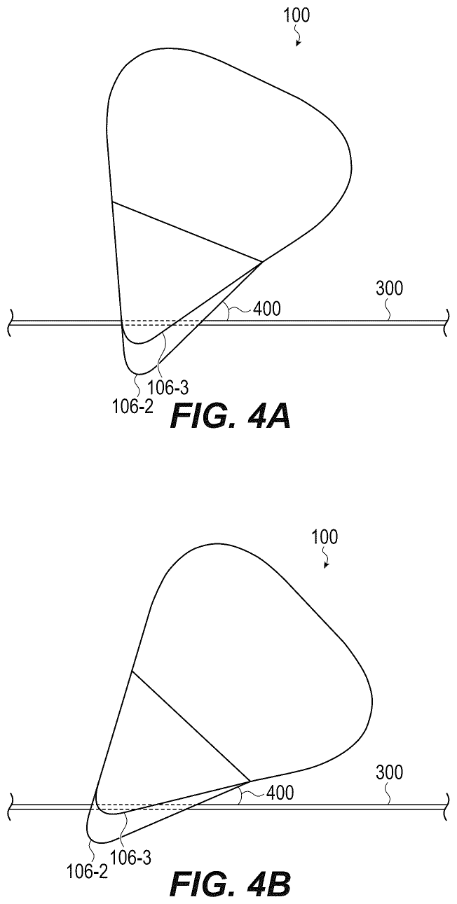

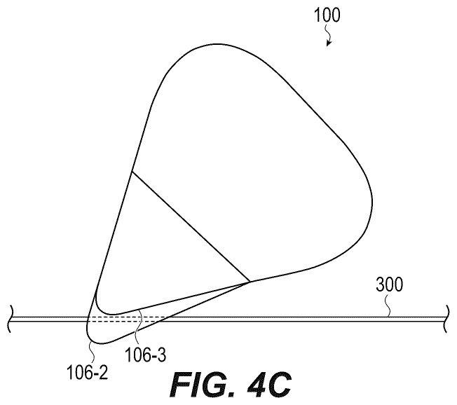

The asymmetrical tine tip offset of the outer tines and the central tine may also help to ensure that the central tine 106-2 will engage the string on each pluck over a range of different pick angles. FIGS. 4A-4B, for example, illustrate the pick 100 being held at different angles about the transverse axis of the pick 100 (e.g., angles 400, 402) relative to the string 300. As shown, the central tine 106-2 is in a position to engage and pluck the string 300 in both orientations. Holding the pick in different orientations may also allow a player to achieve different sounds or otherwise produce different picking dynamics or feel, such as by changing the amount of overlap between the tine(s) and a string, the angle of the tine(s) relative to the string, and the like. For example, as shown in FIGS. 4A-4B, different relative amounts of the central tine 106-2 and the outer tines (represented in this view by tine 106-3) will engage the string depending on the angle at which the pick is held. A player may vary the way that they hold or orient the pick relative to the strings in order to produce the desired sounds and picking feel.

The asymmetrical tine tip offset of the outer and central tines may also allow a user to pick a string with a single tine (e.g., the central tine 106-2), as shown in FIG. 4C, even when the pick is held at an angle to the strings (e.g., rotated about its transverse axis, as shown in FIG. 4C). Thus, a user can easily transition between picking styles where multiple tines engage the string(s), and where only a single tine engages the string, and can do so without needing to significantly change the rotational angle of the pick (where rotational angle corresponds to a rotation about the transverse axis).

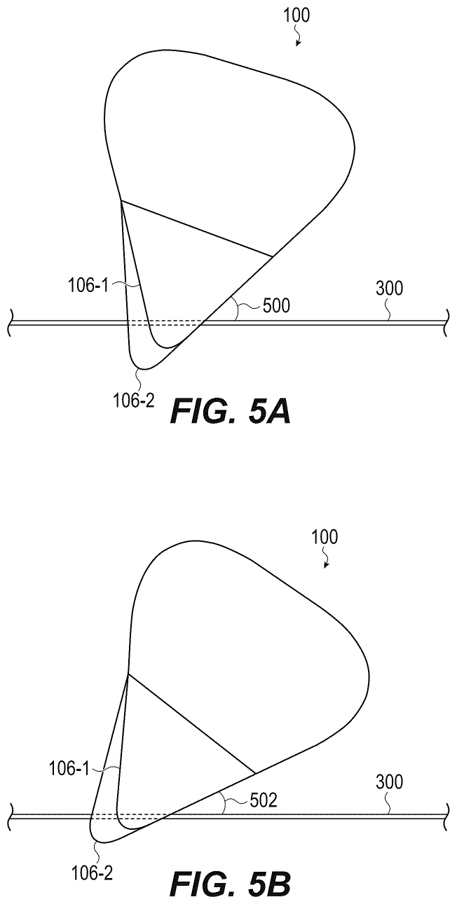

The asymmetrical nature of the tines may also allow a user to achieve different sounds or pick dynamics or feedback by engaging the strings with a different side of the pick 100. For example, FIGS. 4A-4C illustrate the pick 100 generally oriented so that the side of the pick 100 from which the central tine 106-2 protrudes laterally is predominantly facing or engaging the string 300. By contrast, FIGS. 5A-5B illustrate the pick 100 generally oriented so that the opposite side of the pick 100 (e.g., the side along which the tine edges are substantially coplanar) is facing or engaging the string 300. When this side of the pick is used to engage the strings, the resulting sounds, tones, picking feel, and the like, may be different than when the opposite side of the pick is used. This may be due at least in part to the different relative overlap between each tine and the string that is achieved based on the asymmetrical tine offset. Moreover, similar to the examples shown in FIGS. 4A-4C, the user can easily change the manner in which the tines engage the strings (e.g., the relative depth of each tine) by rotating the pick about the transverse axis (represented by angles 500, 502, shown in FIG. 5A and FIG. 5B).

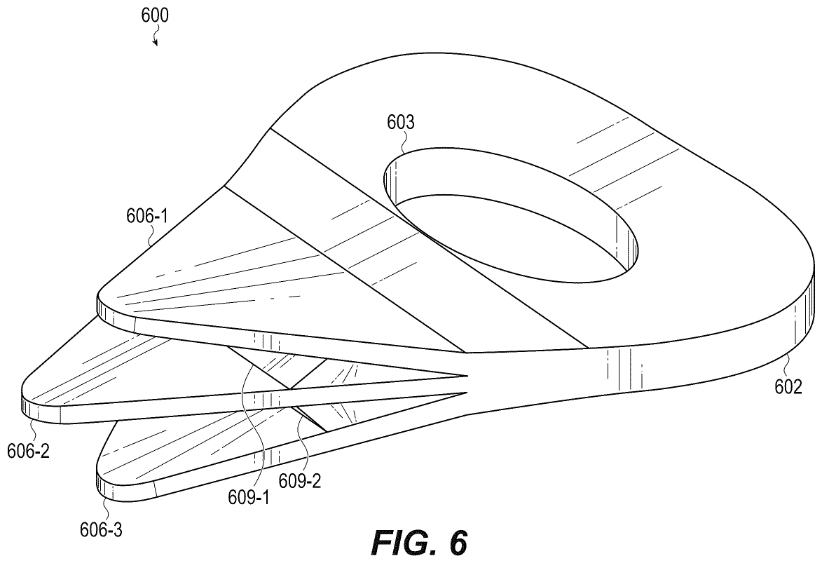

While FIGS. 1A-5B illustrate one example pick configuration that includes multiple tines having asymmetrical or offset tine tips, that is merely one example configuration of a pick using the concepts disclosed herein. For example, FIG. 6 illustrates an example pick 600 that includes multiple, asymmetrically protruding tines. In particular, the pick 600 includes a grip portion 602 and a tine portion 604, where the tine portion 604 includes multiple tines 606, with each tine extending from the grip portion 602. In this example, the grip portion 602 includes a grip enhancing feature, such as a hole 603. The hole 603 may improve a user's grip and prevent or inhibit unintended slipping, dropping, or rotation of the pick. Other grip enhancing features may be provided on the grip portion 602 instead of or in addition to a hole, such as a surface texture, multiple holes (e.g., an array or pattern of smaller holes), ridges, channels, dimples, protrusions, or the like.

The pick 600 also includes support features 609-1, 609-2 positioned between the tines 606. The support features 609 may reduce or otherwise tune the flexibility of each tine. The support features 609 may be used to produce a pick with stiffer tines (relative to the pick 100, for example), and/or to otherwise tune the stiffness of the central tine 606-2 relative to the outer tines 606-1, 606-3. In some cases, the support features 609 effectively shorten the unsupported length of the central tine 606-2 such that the central tine 606-2 has a similar stiffness (as experienced or perceived during picking) as the outer tines 606-1, 606-3. It will be understood that picks may be configured with different tine stiffnesses to achieve different sounds, tones, picking feel, and the like.

FIGS. 7A-7B illustrate an example pick 700 that includes a tine portion 704 having two tines 706-1, 706-2 extending from a grip portion 702. The two tines 706-1, 706-2 may correspond in shape and configuration to the tines 106-1, 106-2 of the pick 100. Thus, for example, the tines 706 may generally project or extend from the grip portion 702 at different angles. For example, as shown in FIG. 7B, the second tine 706-2 may extend from the grip portion 702 along the grip plane, and the first tine 706-1 may extend from the grip portion 702 at an angle 714 (e.g., an oblique angle) relative to a grip plane defined by the grip portion 702. The tips of the tines 706-1, 706-2 may be staggered or offset (relative to each other) in one or more dimensions. For example, as described with respect to the pick 100, the first tine tip 708-1 is offset from the second tine tip 708-2 in the lateral dimension 122 (shown in FIG. 1A), and offset from the second tine tip 708-2 in the longitudinal dimension 120 (shown in FIG. 1A). The pick 700 may produce the same or similar sounds, tones, and picking dynamics as the pick 100. Additionally, since the pick 700 is not symmetrical about the grip plane, the pick 700 may produce other effects. For example, the three tine configuration of the pick 100 may result in upstrokes and downstrokes having a substantially similar sound (e.g., an outer tine engages the string first, followed by the central tine). By contrast, the pick 700 engages the strings differently on upstrokes and downstrokes. In particular, on a downstroke, the first tine 706-1 may engage the string first, followed by the second tine 706-2, while on an upstroke, only the second tine 706-2 may engage the string (e.g., because the first tine 706-1 is shorter in the longitudinal dimension 120 than the second tine 706-2). Thus, a user may select the pick 700 to facilitate different sounds or effects, such as the ability to select between a multi-tine sound and a single-tine sound using different hand or picking directions.

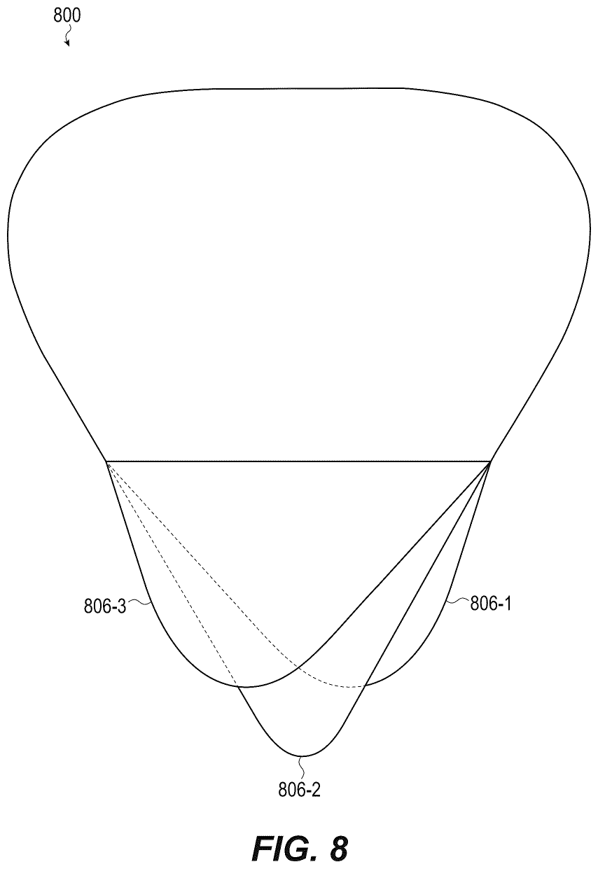

FIG. 8 illustrates an example pick 800 that includes three tines 806-1, 806-2, 806-3, where the outer tines 806-1, 806-3 protrude relative to the central tine 806-2 in opposite lateral directions (when viewed as presented in FIG. 8). More particularly, the tip of the first tine 806-1 protrudes or is offset relative to the central tine 806-2, in the lateral dimension, a first distance, and the tip of the second tine 806-3 protrudes or is offset relative to the central tine 806-2, in the lateral dimension, a second distance that is opposite the first distance. The tines may protrude the same magnitude or different magnitudes (e.g., one tine may protrude laterally relative to the central tine a greater distance than the other). The tine configuration of the pick 800 may produce additional sounds or picking effects due to the difference in string engagement (e.g., angles, depths, etc., of engagement or overlap with the strings) during downstrokes and upstrokes. Additionally, in cases where the outer tines are protrude equal distances in opposite directions, the pick is symmetrical, and the same tine-to-string engagement geometry may exist regardless of which way the pick is held (e.g., the same tine-to-string engagement geometry is achieved regardless of whether the pick is flipped about its longitudinal axis).

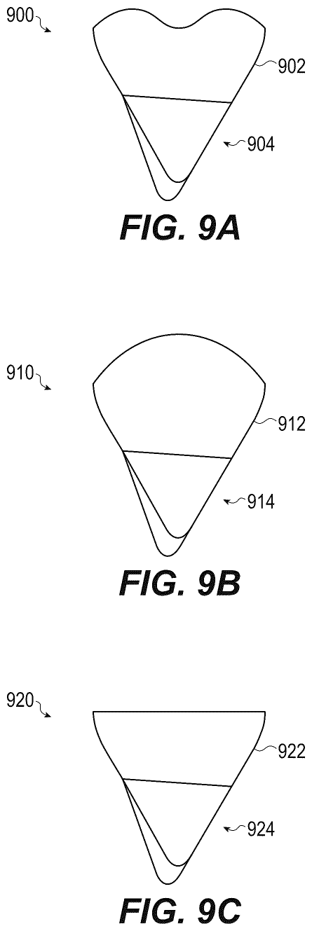

FIGS. 9A-9C illustrate additional example picks with tine portions having asymmetrical or offset tine tips, but with differently configured grip portions. For example, the pick 900 in FIG. 9A includes a tine portion 904 (which may correspond to the tine portions 104, 604, 704, 804) and a grip portion 902. The grip portion 902 may have a recess or indentation along the spine of the pick 900, which may provide a different gripping experience and feel, which may be preferred by some users.

The pick 910 in FIG. 9B includes a tine portion 914 (which may correspond to the tine portions 104, 604, 704, 804) and a grip portion 912. The grip portion 912 may have a prominently rounded spine (as compared to the flat spine of the pick 100, for example), which may provide a different gripping experience and feel, which may be preferred by some users.

The pick 920 in FIG. 9C includes a tine portion 924 (which may correspond to the tine portions 104, 604, 704, 804) and a grip portion 922. The grip portion 922 may have a shorter grip length (along the longitudinal dimension) than the pick 100, and may have a flat or linear spine. In this example, the spine may be angled (as shown), resulting in an asymmetrical grip portion 922 (e.g., having different lengths, along the longitudinal dimension, at the sides of the grip portion 922). This configuration may provide a different gripping experience and feel, which may be preferred by some users.

Tine portions having multiple tines with asymmetrical or offset tine tips may be incorporated into a pick in various manners. For example, in the pick 100, the first and third tines 106-1, 106-3 join the grip portion 102 at a distinct vertex. Stated another way, the outer surfaces of the grip portion 102 may be substantially planar, and the outer surfaces of the tines 106-1, 106-3 may be substantially planar, and the planes meet at a distinct vertex, which may be visible and tactilely perceptible along the outer surfaces of the pick 100.

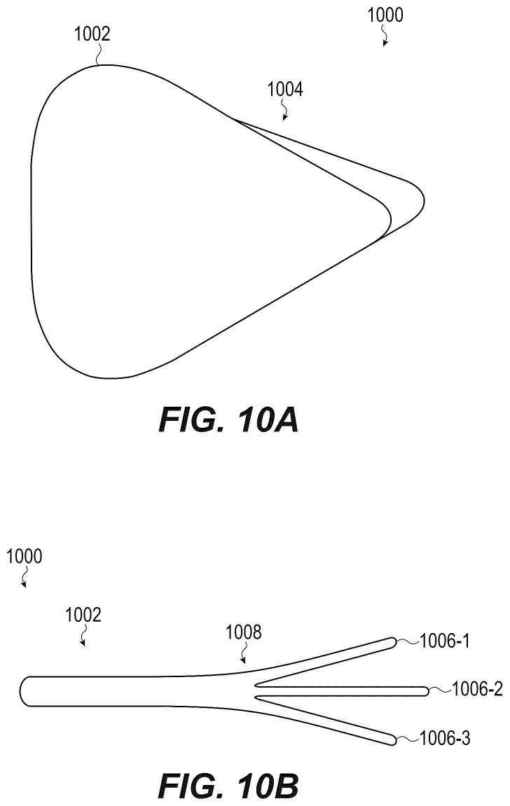

FIGS. 10A-10B illustrate another example pick 1000 having multiple tines with asymmetrical or offset tine tips, in which the tines and/or the tine portion joins the grip portion at a curved interface. For example, the pick 1000 includes a grip portion 1002 and a tine portion 1004 extending from the grip portion. The tine portion 1004 includes tines 1006-1, 1006-2, 1006-3, which may have asymmetrical or offset tine tips, as described herein. As shown in FIG. 10B, the outer tines 1006-1, 1006-3 join the grip portion 1002 at a curved interface 1008. In this example, there may be no distinct vertex or discontinuity between the grip portion 1002 and the outer tines 1006-1, 1006-3.

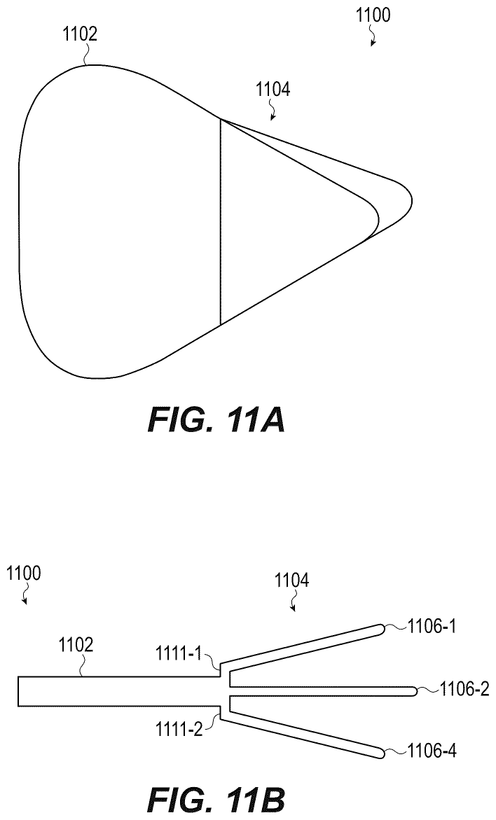

FIGS. 11A-11B illustrate another example pick 1100 having multiple tines with asymmetrical or offset tine tips, in which the tines and/or the tine portion joins the grip portion at a shoulder structure. The shoulder structure may define a discontinuous step where the tines join the grip portion. For example, the pick 1100 includes a grip portion 1102 and a tine portion 1104 extending from the grip portion. The tine portion 1104 includes tines 1106-1, 1106-2, 1106-3, which may have asymmetrical or offset tine tips, as described herein.

As shown in FIG. 11B, the outer tines 1106-1, 1106-3 join the grip portion 1102 at a shoulder structure. For example, the first tine 1106-1 joins the grip portion 1102 at a first shoulder 1111-1 and the third tine 1106-3 joins the grip portion 1102 at a second shoulder 1111-2. The shoulders 1111 may extend generally perpendicularly from the grip portion 1102, as shown, or they may extend at a different oblique angle. The length of the shoulders 1111 (e.g., in the transverse direction to the grip portion 1102) may be between about 0.5 mm and about 2.0 mm, or any other length. The shoulder structure may facilitate greater variations in tine angles and inter-tine distances. For example, the shoulder structure may allow shallower tine angles (e.g., closer to parallel with the central tine 1106-2 and/or the grip 1102) while maintaining a same inter-tine distance.

The picks described herein may be formed from various materials or combinations of materials. Example materials may include polymers such as nylon, phenolic, celluloid, polyoxymethylene, urethane, acrylic, or the like. In some cases, reinforcing materials such as carbon or glass fiber, aramid fiber, or the like, may be included in a polymer binder or matrix. In some cases, the grip portion and the tine portion may be formed of different materials, such as a grip portion formed from celluloid and a tine portion formed from nylon. In some cases, the tines may be formed from different materials. For example, the central tine may be formed from a first material (which may be the same as the material of the grip portion, such as nylon), and the outer tines may be formed from a second, different material (such as celluloid). In some cases, all of the tines are formed of different materials, which may provide additional sounds, tones, and picking dynamics or feedback.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. Also, when used herein to refer to positions of components, the terms above, below, over, under, left, or right (or other similar relative position terms), do not necessarily refer to an absolute position relative to an external reference, but instead refer to the relative position of components within the figure being referred to. Similarly, horizontal and vertical orientations may be understood as relative to the orientation of the components within the figure being referred to, unless an absolute horizontal or vertical orientation is indicated. As used herein, oblique and oblique angle may be used to refer to lines, planes, surfaces, objects, or component portions that are neither parallel nor perpendicular to one another.

Features, structures, configurations, components, techniques, etc. shown or described with respect to any given figure (or otherwise described in the application) may be used with features, structures, configurations, components, techniques, etc. described with respect to other figures. For example, any given figure of the instant application should not be understood to be limited to only those features, structures, configurations, components, techniques, etc. shown in that particular figure. Similarly, features, structures, configurations, components, techniques, etc. shown only in different figures may be used or implemented together. Further, features, structures, configurations, components, techniques, etc. that are shown or described together may be implemented separately and/or combined with other features, structures, configurations, components, techniques, etc. from other figures or portions of the instant specification.

What is claimed is:

1. A plectrum for plucking or strumming a stringed instrument, the plectrum comprising:
a grip portion defining a grip plane;
a first tine extending from the grip portion at an oblique angle relative to the grip plane and defining a first tine tip; and
a second tine extending from the grip portion along the grip plane and defining a second tine tip that protrudes beyond the first tine tip in both a lateral dimension and a longitudinal dimension.

2. The plectrum of claim 1, wherein:
the oblique angle is a first oblique angle; and
the plectrum further comprises a third tine extending from the grip portion at a second oblique angle relative to the grip plane and defining a third tine tip.

3. The plectrum of claim 2, wherein:
the third tine defines a third tine tip; and
the second tine tip protrudes beyond the third tine tip in both a lateral dimension and a longitudinal dimension.

4. The plectrum of claim 2, wherein:
the first tine defines a first edge extending from a first side of the grip portion and a second edge extending from a second side of the grip portion;
the second tine defines a third edge extending from the first side of the grip portion and a fourth edge extending from the second side of the grip portion;
the third tine defines a fifth edge extending from the first side of the grip portion and a sixth edge extending from the second side of the grip portion; and
the first edge and the fifth edge are coplanar, and the third edge is noncoplanar with the first edge and the second edge.

5. The plectrum of claim 4, wherein the second edge, the fourth edge, and the sixth edge are coplanar.

6. The plectrum of claim 1, wherein the second tine tip protrudes beyond the first tine tip in the longitudinal dimension by between about 0.5 mm and about 4.0 mm.

7. The plectrum of claim 1, wherein the second tine tip protrudes beyond the first tine tip in the lateral dimension by between about 0.25 mm and about 2.0 mm.

8. A pick for a stringed instrument, comprising:
a grip portion configured to be grasped by a user; and
a tine portion extending from the grip portion and comprising at least two tines, each of the at least two tines configured to pluck a string of the stringed instrument, the at least two tines comprising:
a first tine extending from the grip portion and defining a first tine tip; and
a second tine extending from the grip portion and defining a second tine tip; wherein
a first line extending from a centroid of the grip portion to the first tine tip is oblique to a second line from the centroid of the grip portion to the second tine tip when the first and second lines are projected into a plane defined by a surface of the first tine.

9. The pick of claim 8, wherein the tine portion further includes a third tine extending from the grip portion and defining a third tine tip.

10. The pick of claim 9, wherein a third line extending from a centroid of the grip portion to the third tine tip is oblique to the second line from the centroid of the grip portion to the second tine tip when the third and second lines are projected into a plane defined by the surface of the first tine.

11. The pick of claim 9, wherein the second tine extends along a same plane as the grip portion.

12. The pick of claim 11, wherein:
the first tine is oriented along a first tine plane that extends from the grip portion at a first angle; and
the third tine is oriented along a second tine plane that extends from the grip portion at a second angle.

13. The pick of claim 12, wherein a magnitude of the first angle is equal to a magnitude of the second angle.

14. The pick of claim 8, wherein the second tine has a greater surface area than the first tine.

15. A pick for a stringed instrument, comprising:
a grip portion configured to be grasped by a user;
a tine portion extending from the grip portion and comprising at least two tines, each of the at least two tines configured to pluck a string of the stringed instrument, the at least two tines comprising:
a first tine extending from the grip portion and defining a first tine tip; and
a second tine extending from the grip portion and defining a second tine tip, the second tine tip offset from the first tine tip in at least a lateral dimension and a longitudinal dimension.

16. The pick of claim 15, wherein the tine portion further includes a third tine extending from the grip portion and defining a third tine tip, the second tine tip offset from the third tine tip in at least the lateral dimension and the longitudinal dimension.

17. The pick of claim 16, wherein the second tine tip is offset from the first tine tip and the second tine tip, in the lateral dimension, by a same distance.

18. The pick of claim 17, wherein the second tine tip is offset from the first tine tip and the second tine tip, in the longitudinal dimension, by a same distance.

19. The pick of claim 16, wherein the first tine tip and the third tine tip are set apart from the second tine tip by a same distance.

20. The pick of claim 16, wherein the pick is symmetrical about a plane defined by the grip portion.
